(19) United States
(12) Patent Application Publication
(10) Pub. No.: US 2025/0188998 A1
(43) Pub. Date: Jun. 12, 2025

(54) ADAPTIVE PLATFORM FOR HYDRAULIC CLUTCHES

(71) Applicant: PT Tech, LLC, Wadsworth, OH (US)

(72) Inventor: Brian J. Peet, Akron, OH (US)

(21) Appl. No.: 18/845,204

(22) PCT Filed: Mar. 22, 2022
(86) PCT No.: PCT/US2022/021276

§ 371 Date: Sep. 9, 2024

(51) Int. Cl. F16D 25/12; F16D 48/04

(52) U.S. Cl. CPC F16D 25/123; F16D 48/04

(57) ABSTRACT

A clutch assembly has a housing with a cooling path and a piston actuation path, selectively connected. In a dry clutch, a single reversible power pack selectively services both paths. In a wet clutch, a single unidirectional motor drives two pumps in unison, one servicing the cooling path and the other the piston actuation path. Inputs to a filter selectively receive solid or orifice plugs, the latter controlling the flow and pressure of coolant oil to a cooling passage matrix. Various plugs with inlets to the filter control the source of cooling oil employed by the clutch. A first implementation allows for use of the hydraulic system of the host piece of equipment or known hydraulic systems, while a second implementation provides a self-contained source of hydraulic oil, which, through the hydraulic power units described, services both the actuating system and the cooling matrix of the clutch.

### TECHNICAL FIELD

The invention herein resides in the art of power transmission devices and, more particularly, to clutch mechanisms for selectively engaging and disengaging power drive sources with driven implements and devices. Particularly, the invention relates to hydraulic clutch mechanisms of the torque limiting type. More particularly, the invention relates to clutches requiring fluidic cooling of the operative parts. Specifically, the invention relates to clutches sharing a single isolated power source for both clutch actuation and cooling for both dry and wet clutch adaptations, as well as being adaptable to previous machine-dependent hydraulics.

### BACKGROUND ART

The use of clutches to selectively engage or disengage power sources with a driven implement is well known. Torque limiting clutches are often employed to prevent damage from overloads, blockages, jams and the like. Clutches typically fall into two different categories and are generally referred to as “wet” or “dry” clutches. Wet clutches are of such a nature that the actuating oil provides torque transmission interface cooling and lubrication to mating and moving parts of the clutch, where oil cooling is required at all times. In contradistinction, dry clutches do not employ an oiled torque transmission medium, but rather provide a network of oil flow passages for coolant to flow to moving parts of the clutch, whether the coolant is separate from or the same as the hydraulic actuating fluid or oil. The invention herein is adapted for implementation with both dry and wet clutches.

Those skilled in the art understand that clutches must interface well between the drive and driven units. While drive units typically have their own hydraulic systems, the clutch supplier needs to have a reliable source of hydraulics for its operation. Most particularly, the hydraulics necessary for operating the clutch need to be known and reliable, both as to pressure and fluid flow. When a clutch is to be developed and/or supplied to a known customer with a hydraulic source, the clutch supplier is often able to use the customer's hydraulic source for the customer's drive and/or driven unit for operating the clutch. Such is typically the consequence of ongoing relationships between the clutch manufacturer and the power source and/or implement provider. Accordingly, when a clutch is to be provided to a known customer and the clutch supplier is fully informed as to the pressure and flow characteristics of the implement supplier, the marriage between the clutch and implement are readily achieved and reliable clutch actuation and cooling can occur.

When clutches are to be supplied to new customers or those without a reliable and consistent hydraulic source, applicant has found that it is best that the clutch hydraulics be provided by the clutch manufacturer for purposes of controlling both clutch actuation and cooling. The risks inherent with the use of hydraulics that are either unknown or unreliable, and not a source of reliable and consistent provision of hydraulic pressure, can be avoided.

However, economy is best served when a single clutch platform can be employed to serve a system having a known reliable hydraulic source, as well as those for which the hydraulic source must be provided by the clutch manufacturer to avoid unnecessary risks. It is most desirable that the adaptation to either situation is easily and cost-effectively achieved. Accordingly, there is a need in the art for a clutch having an adaptable platform to accommodate implementation with various power and implement systems-those having known reliable sources of hydraulics and those having either unknown or unreliable sources.

In the past, clutch actuation and clutch cooling have typically employed separate and distinct motors and pumps, or a single high-power hydraulic supply to satisfy the significantly different demands of clutch actuation and clutch cooling. This has aggravated both the cost of manufacture and the cost of operation of such clutches, both wet and dry.

### DISCLOSURE OF INVENTION

In light of the foregoing, it is a first aspect of the invention to provide a hydraulic clutch adaptable for use in systems having either a reliable or unreliable or an unavailable hydraulic source.

A further aspect of the invention is the provision of a hydraulic clutch adapted for selective interconnection with either an electrohydraulic power unit or the high-pressure hydraulic oil supply of a power source associated with the drive mechanism with which the clutch is employed.

Still a further aspect of the invention is to provide a hydraulic clutch selectively adaptable for use with an electrohydraulic power unit or the high-pressure hydraulic oil supply of a power source by interchanging between a solid plug and an orifice plug in the clutch system platform.

Yet a further aspect of the invention is the provision of a hydraulic clutch selectively employing an electrohydraulic power unit having a reversible motor and pump for alternatively supplying high-pressure actuation hydraulic oil and low-pressure cooling hydraulic oil.

Still a further aspect of the invention is the provision of a hydraulic clutch selectively employing high-pressure hydraulic oil from a power source to the clutch piston for clutch actuation and to a pressure-reducing orifice for clutch cooling.

Yet another aspect of the invention is the provision of a hydraulic clutch assembly employing a single motor to operate a pair of hydraulic pumps, one for clutch actuation and the other for clutch cooling.

An additional aspect of the invention is the provision of a hydraulic clutch assembly of an adaptable platform for implementation with both dry and wet clutches, employing the economy of a single motor servicing both clutch cooling and clutch actuation.

Another aspect of the invention is the provision of a dry clutch having a single reversible motor driving a single pump for effecting both clutch actuation and clutch cooling.

Yet a further aspect of the invention is the provision of a wet clutch having a single unidirectional motor driving a pair of pumps, one effecting clutch actuation and another clutch cooling.

Still a further aspect of the invention is to provide a hydraulic clutch having an adaptable platform as aforesaid, which is reliable and durable in operation, and readily devised from employing state-of-the-art devices and techniques.

The foregoing and other aspects of the invention that will become apparent as the detailed description proceeds are achieved by a hydraulic clutch assembly, comprising a housing; a cooling path within said housing; a piston actuation path within said housing; pump means in selective communication with said cooling path and said piston actuation path for introducing pressurized hydraulic fluid into said cooling path and said piston actuation path; and a single motor interconnected with and driving said pump means.

Additional aspects of the invention that will become apparent herein are achieved by a hydraulic clutch assembly adaptable for implementation with alternative sources of hydraulic oil, comprising: a housing; a piston operative within a piston cavity within said housing, said cavity being in a first selective fluid communication with oil cooling passageways within said housing; a piston operative within a piston cavity within said housing, said cavity being in a first selective fluid communication with oil cooling passageways within said housing; an inlet in said housing in a second selective fluid communication with said oil cooling passageways; and wherein said first and second selective fluid communications are mutually exclusive of each other.

### BRIEF DESCRIPTION OF THE DRAWINGS

For a complete understanding of the objects, techniques and structures of the invention, reference should be made to the following detailed description and accompanying drawings wherein:

FIG. 1 is a partial sectional view of a dry clutch housing according to the invention in its adaptation for cooling supplied by a reliable external source;

FIG. 2 is a partial schematic view of the clutch housing of FIG. 1 in its adaptation for use with an electrohydraulic power unit for both clutch actuation and cooling;

FIG. 3 is a hydraulic schematic diagram of the power unit for the dry clutch adaptation of FIG. 2;

FIG. 4 is a control circuit block diagram for use in association with the hydraulic schematic diagram of FIG. 3; and

FIG. 5 is a hydraulic schematic and control diagram of a power unit for a wet clutch adaptation of the concepts, aspects and benefits of the invention.

### DETAILED DESCRIPTION OF PREFERRED EMBODIMENTS

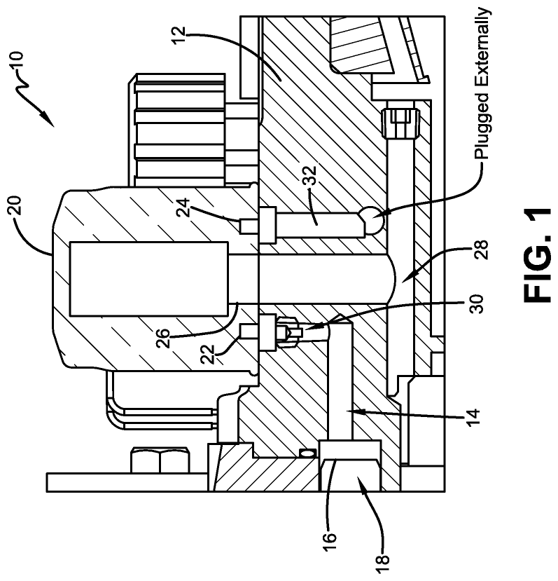

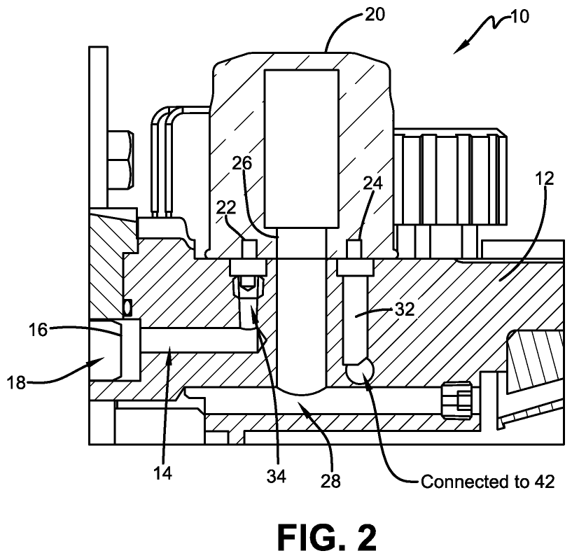

Referring now to the drawings and more particularly FIGS. 1 and 2, an appreciation can be obtained as to the adaptive nature of the hydraulic clutch assembly 10 of the invention. It will be appreciated by those skilled in the art that the invention may incorporate any of various types of clutch systems or structures, with the invention itself being directed toward the adaptability of those clutch structures to be employed with any of various types of hydraulic systems. The invention is here adapted to dry clutch structures that incorporate a housing 12 having a pressurized oil input 14 in communication with an actuating piston 16 maintained within a piston cavity 18.

Differing from prior art dry clutch assemblies, the present invention contemplates an oil filter 20, having two inlets 22 and 24.

The structure of FIG. 1 is shown as particularly adapted for use in systems having a reliable source of hydraulic oil, both as to flow rate and pressure. In systems of this nature, and particularly as shown in FIG. 1, the filter inlet 22 is employed. The filter inlet 24 is employed for adaptation in systems employing a power unit for generation of hydraulic pressure for both clutch actuation and cooling. The filter 20 is provided with a single outlet 26, which passes to a matrix of interconnected oil cooling passageways 28 within the housing 12 and among the operative parts and ultimately to a sump.

An orifice plug 30 is interposed between the pressurized oil input 14 and the filter inlet 22 to reduce the hydraulic oil pressure to meter flow at very low pressures to the cooling circuit of passageways 28. The flow rate associated with the cooling hydraulic oil is significantly greater than that required for actuating/holding the piston in engagement. Similarly, the pressure required for actuating/holding the piston in engagement is much greater than for circulating cooling oil. Indeed, the actuating pressure is routinely between 40 and 70 times the pressure necessary for passing of the coolant oil. High pressure with high flow rate is very power demanding. But, power demands are greatly reduced by providing for low pressure/high flow or high pressure/low flow according to the present invention.

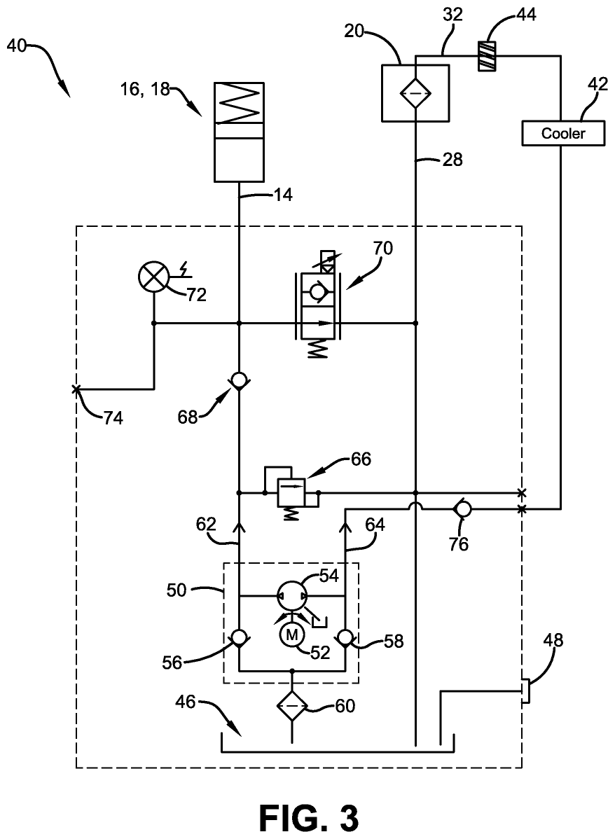

In the dry clutch embodiment of FIG. 1, the passage 32 between the inlet to the housing 12 (shown in FIG. 3) and the filter inlet 24 is plugged by a solid threaded plug or the like, indicated as element 44 in FIG. 3.

With reference now to FIG. 2, an appreciation can be had of the adaptation of the hydraulic clutch assembly 10 for use in a system in which a power unit is provided to ensure consistency of hydraulic oil pressure and flow rate without dependence upon the hydraulic systems of the host implement employing the clutch. As shown in FIG. 2, a solid plug 34 replaces the orifice plug 30 of the embodiment of FIG. 1, and the plug (44, as shown in FIG. 3) is removed between the cooling passages 32 and housing 12 to accommodate connection to a cooler associated with the power unit as presented below. The remaining structure, including the piston 16 and piston cavity 18 remain the same as between FIG. 2 and FIG. 1.

With reference now to FIG. 3, an appreciation can be obtained for the structure and operation of the hydraulic control power unit 40 as employed in association with the implementation of the hydraulic clutch assembly 10 as shown in FIG. 2. The power unit 40 provides both clutch control by communication with the piston 16 and cavity 18 and cooling as by communication with the cooler 42 and cooling passageways 28. It will be appreciated that cooler 42 is interconnected with the filter 20 by removal of the plug 44 placed in the housing to close the passage 32 to the filter. That plug 44 is simply replaced with a coupling to interconnect with the cooler.

The power unit 40 is shown as providing a sump 46 for maintaining and recirculating hydraulic fluid, along with a fill cap 48 for adding such fluid as necessary.

A hydraulic oil distributor 50 is provided to selectively provide hydraulic oil to either the actuating piston 16 and associated cavity 18, or to the cooler 42 and cooling passages 28. This is primarily achieved by the implementation of a reversible or bidirectional motor 52 interconnected with and driving a pump 54 with appropriate check valves 56, 58 being provided in communication with the filter 60 at the sump 46.

The hydraulic oil distributor 50 communicates with a piston actuation or control path 62 or a cooling path 64, dependent upon the rotational direction of the reversible motor 52 driving the pump 54. The hydraulic oil distributor 50 mutually exclusively services either the piston and its cavity 16, 18, or the oil cooling passageways 28, as a function of the direction of motor rotation.

According to a preferred dry clutch embodiment of the invention, when the motor 52 is caused to rotate clockwise, the path 62 receives hydraulic oil from the motor 52 and pump 54. A pressure relief valve 66 is provided to prevent over-pressurization of the housing block, while a check valve 68 is provided to hold pressure within the cavity 18 once actuation of the piston has been achieved. A normally open proportional valve 70, controlled in a manner to be discussed below, is provided to allow for control of the pressurization of the cavity 18 and to seal and hold that pressure when a desired level is reached.

A pressure monitor 72 is provided in the path 62 to produce an output signal correlating with the pressure in the path 62 and piston cavity 18. A port 74 is provided for receiving an external pressure gauge for optical or other appropriate readings.

As will be discussed further below, pressure is monitored by the pressure monitor 72 and, upon the piston cavity 18 reaching a desired actuation pressure, the normally open proportional valve 70 is fully closed, and the check valve 68 holds the actuating pressure in the cavity 18.

With the clutch actuated as by the piston 16, the power unit 40 then switches to counterclockwise rotation of the motor 52, driving the hydraulic fluid through the cooling path 64. The pump 54, driven by the motor 52, causes the cooling fluid to flow at lower pressure than the actuating pressure in the path 62. A check valve 76 is provided within the cooling path 64 and before the cooler 42. A coupler may be used to replace the plug 44 (as employed in the adaptation of FIG. 1) in order to interconnect the cooler 42 with the passage 32 and to the filter 20. From exiting the filter 20, the cooled hydraulic oil passes through the oil cooling passageways 28 and thence to the sump 46.

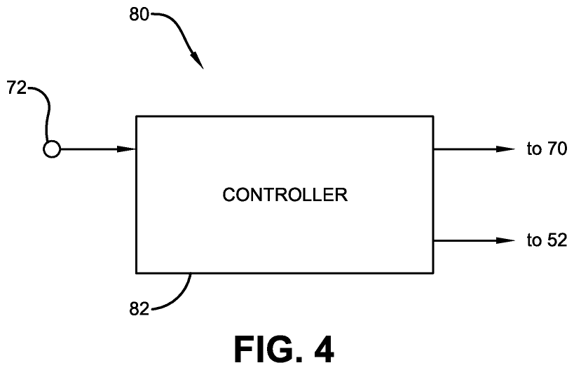

As shown in FIG. 4, the control system for the power unit 40 is designated generally by the numeral 80. The system 80 includes a controller 82, such as a dedicated microprocessor, chip, or the like. The controller 82 receives temperature, pressure, input/output speed, engine CAN (Controller Area Network) signals and signals from the pressure monitor 72. Based upon those signals, the controller 82 controls the normally open proportional valve 70 in such a way as to control the rate of actuation of the piston, or to fully close the valve 70, in order to place the piston in a holding condition against the bias of its return spring.

It is contemplated that the controller 82 may further provide control signals to the motor 52 to regulate not only its direction, but also its electrical current draw for servicing operations and the like. It is further contemplated that its speed of operation may also be controlled by the controller 82. It is known that increased pressure increases power demand, which necessarily lowers flow rate due to the motor torque vs. speed curve. While mechanical power packs typically have fixed displacement and speed pumps, the invention also contemplates power electronics to control speed.

Employing the system of the invention, the entirety of the hydraulic system is controlled by and responsive to the specifications of the clutch and its manufacturer. By holding pressure in the piston cavity 18, the motor 52 can run at lower power consumption rates for the vast majority of the time. Since cooling requires flow on the order of in excess of ninety-five percent (95%) of the time, and piston actuation less than five percent (5%) of the time, great energy savings are realized. This is particularly true since the power consumption for actuating the piston is often as much as 10 times that required for flowing the coolant oil through the clutch cooling matrix. By providing a holding mechanism for keeping the piston actuated, while allowing the motor to revert at a lower power consumption rate for cooling, significant energy savings are achieved, as is wear on the clutch system itself.

The pressure monitor 72 and controller 82 continue to communicate even after clutch actuation to ensure that the pressure within the cavity 18 is sufficient to maintain clutch engagement. If the pressure begins to drop due to temperature, leakage, or the like, the controller 82 can again reverse the direction of the motor operation to bring the pressure of the cavity 18 to a pressure sufficient to ensure holding of the clutch in an engaged position, and return can then be made to the cooling operation.

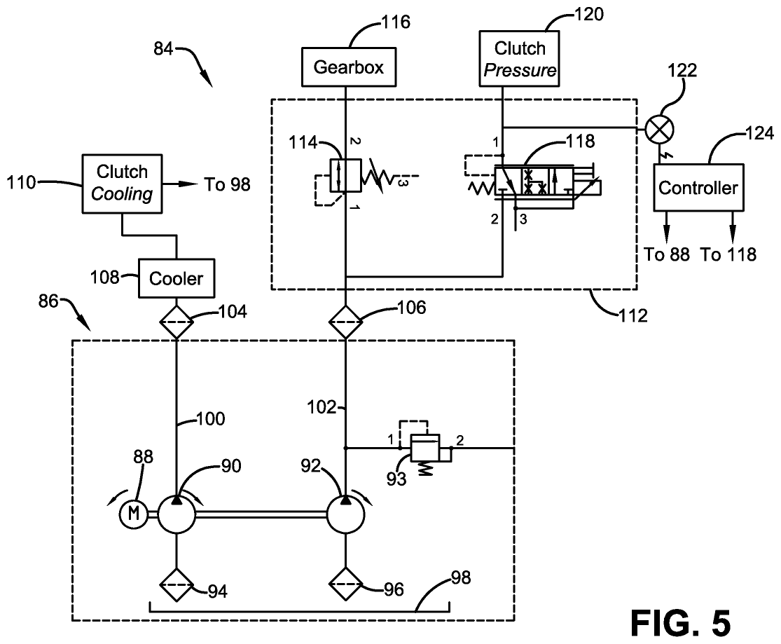

With reference now to FIG. 5, an appreciation of an adaptation of the invention for implementation with a wet clutch can be obtained. The hydraulic schematic and controller for wet clutch applications is shown and designated by the numeral 84. Here again, a power unit is employed as designated by the numeral 86. For the wet clutch adaptation, the power unit 86 employs a unidirectional motor 88 in driving interconnection with hydraulic pumps 90 and 92. The pumps 90, 92 draw hydraulic fluid through respective coarse filters 94, 96 from the sump 98. As further discussed below, the pump 90 attends to the cooling of the clutch, while the pump 92 provides the power drive for clutch actuation. In one embodiment of the invention, the pump 90 provides on the order of 8 times the flow rate at 10% of the pressure.

With attention now to the pump cooling function in the wet clutch adaptation, the unidirectional motor 88 drives the hydraulic pump 90 to draw hydraulic fluid from the sump 98 through the screen filter 94 and a cooling path hydraulic conduit 100 to the cooling portion of the associated clutch assembly. The hydraulic fluid is passed through a fine material filter 104, thence through a cooler or chiller 108 for introduction into the clutch cooling conduits 110 servicing the clutch housing and heat generating mechanisms, in standard fashion. From the clutch cooling conduits 110, the hydraulic cooling fluid is returned to the sump 98.

While driving the pump 90 to service the cooling functions of the associated clutch, the motor 88 also drives the hydraulic pump 92 to service the clutch actuation unit 112 of the associated clutch. As shown, the pump 92 passes hydraulic fluid from the sump 98 through the piston actuation path hydraulic conduit 102 and the fine material filter 106 to the clutch actuation unit 112. A relief valve 93 is interposed with the conduit 102 to prevent over-pressurization. Pressurized hydraulic fluid is passed to the sequence valve 114. The valve 114 assures the introduction of hydraulic fluid at a set pressure to the proportional control valve 118 and exhausts excess hydraulic fluid to the gearbox 116 for lubrication and cooling. The pressure applied to the proportional control valve 118 ensures the application of sufficient pressure to the clutch pressure plate or piston 120 to maintain clutch actuation. A pressure monitor 122 communicates with the output of the proportional control valve 118 to monitor the actual pressure of hydraulic fluid applied to the clutch pressure plate or piston.

A controller 124, such as a dedicated microprocessor chip or the like, is interposed between and among the motor 88, proportional control valve 118, and pressure monitor 122 to provide the necessary controls for operation of this hydraulic system for economically controlling the cooling and actuation of a wet clutch assembly. At startup, the controller 124 activates the unidirectional motor 88 to activate in tandem the pumps 90, 92, providing service for clutch cooling and actuation.

The controller 124 monitors the clutch actuation pressure through the pressure monitor 122 and adjusts the proportional control valve 118 to assure that sufficient actuating pressure is applied to the clutch during actuation.

In a preferred embodiment of the system of the invention for implementation with a wet clutch, the pump 90 provides on the order of 8 times the flow rate at 10% of the pressure. The sequence valve 114 is provided to maintain a pressure higher than clutch actuation pressure, bleeding off excess flow by passage of hydraulic fluid to the gearbox for additional lubrication and cooling. The proportional control valve 118 receives the pressurized hydraulic fluid as set by the sequence valve 114 and is regulated by the controller 124 to maintain a desired pressure as monitored by the pressure monitor 122.

It should now be appreciated that the present invention provides features for both dry and wet clutches that employ the economy of a single motor servicing both the clutch actuation and cooling functions. In the dry clutch adaptation, the single motor is reversible, driving a pump in a first direction for clutch actuation, and in a second direction for clutch cooling. In the wet clutch adaptation, a single, non-reversible motor is employed to drive a pair of pumps, a first for clutch cooling, and a second for clutch actuation. In both adaptations, a single motor is employed, accommodating a reduction in hardware expenses, and more importantly a reduction in power consumption and expense of operation. The reduction in power consumption is on the order of 80-95%, with a valve layout that is vastly simplified over the prior art.

Thus it can be seen that the various aspects of the invention have been achieved by the structure presented and described above. While in accordance with the patent statutes only the best known and preferred embodiment of the invention has been presented and described in detail, the invention is not limited thereto or thereby. Accordingly, for an appreciation of the scope and breadth of the invention reference should be made to the following claims.

1. A hydraulic clutch assembly, comprising:
a housing;
a cooling path within said housing;
a piston actuation path within said housing;
a pump in selective communication with said cooling path and said piston actuation path for introducing pressurized hydraulic fluid into said cooling path and said piston actuation path; and
a single motor interconnected with and driving said pump.

2. The hydraulic clutch assembly as recited in claim 1, wherein said single motor is a reversible motor.

3. The hydraulic clutch assembly as recited in claim 2, wherein said pump comprises a single hydraulic pump mutually exclusively driving said cooling path and said piston actuation path, dependent upon a direction of rotation of said reversible motor.

4. The hydraulic clutch assembly as recited in claim 3, wherein said piston actuation path comprises a proportional valve in communication with a piston cavity maintaining a piston therein, and a check valve interposed between said piston cavity and said single hydraulic pump.

5. The hydraulic clutch assembly as recited in claim 4, wherein said proportional valve is normally open and closes upon said piston cavity reaching an actuating pressure.

6. The hydraulic clutch assembly as recited in claim 5, wherein said check valve and said proportional valve hold said actuating pressure within said piston cavity when said direction of rotation of said reversible motor drives said cooling path.

7. The hydraulic clutch assembly as recited in claim 6, wherein said cooling path comprises a cooler in communication with oil cooling passageways within said housing.

8. The hydraulic clutch assembly as recited in claim 1, wherein said single motor is a unidirectional motor.

9. The hydraulic clutch assembly as recited in claim 1, wherein said pump means comprises a first hydraulic pump driving said cooling path and a second hydraulic pump driving said actuation path, said motor driving said hydraulic pumps in unison.

10. The hydraulic clutch assembly as recited in claim 9, wherein said first hydraulic pump operates at a higher flow rate and lower pressure than said second hydraulic pump.

11. The hydraulic clutch assembly as recited in claim 10, wherein said actuation path comprises a first valve providing hydraulic fluid at a set pressure to a second valve sufficient to ensure said second valve maintains actuation of a piston in said piston actuation path.

12. The hydraulic clutch assembly as recited in claim 1, wherein said selective communication of said pump with said cooling path and said piston actuation path causes said hydraulic fluid to be introduced into said cooling path at a greater flow rate and less pressure than into said piston actuation path.

13. A hydraulic clutch assembly adaptable for implementation with alternative sources of hydraulic oil, comprising:
a housing;
a piston operative within a piston cavity within said housing, said cavity being in a first selective fluid communication with oil cooling passageways within said housing;
an inlet in said housing in a second selective fluid communication with said oil cooling passageways; and
wherein said first and second selective fluid communications are mutually exclusive of each other.

14. The hydraulic clutch assembly adaptable for implementation with alternative sources of hydraulic oil according to claim 13, wherein said mutually exclusive communications are achieved by a selective interpositioning of plugs within certain of said first and second selective fluid communications.

15. The hydraulic clutch assembly adaptable for implementation with alternative sources of hydraulic oil according to claim 14, wherein said plugs are taken from a group comprising solid plugs precluding fluid communication and orifice plugs restricting fluid communication.

16. The hydraulic clutch assembly adaptable for implementation with alternative sources of hydraulic oil according to claim 15, wherein said orifice plugs effect a pressure and flow of fluid through said oil cooling passageways.

17. The hydraulic clutch assembly adaptable for implementation with alternative sources of hydraulic oil according to claim 16, further comprising an oil filter interposed between said oil cooling passageways and said first and second selective fluid communications.

18. The hydraulic clutch assembly adaptable for implementation with alternative sources of hydraulic oil according to claim 17, wherein said first selective fluid communication is blocked by a solid plug and said second selective fluid communication is open to a cooler, and further comprising a hydraulic control power unit interposed between said cooler and said piston cavity.

19. The hydraulic clutch assembly adaptable for implementation with alternative sources of hydraulic oil according to claim 18, wherein said hydraulic control power unit comprises a reversible motor interposed among a hydraulic oil sump, piston control path, and cooling path.

20. The hydraulic clutch assembly adaptable for implementation with alternative sources of hydraulic oil according to claim 19, wherein a rotational direction of said motor controls passage of hydraulic oil alternatively between said piston control path and cooling path.
